(19) United States
(12) Patent Application Publication
(10) Pub. No.: US 2011/0141335 A1
(43) Pub. Date: Jun. 16, 2011

(54) LENS MODULE OF AN IMAGING DEVICE AND A METHOD OF USING THE SAME

(75) Inventors: WEN-CHIEH CHENG, Taipei (TW); CHIEN-HSIN LU, Taipei (TW)

(73) Assignee: ABILITY ENTERPRISE CO., LTD., Taipei (TW)

(21) Appl. No.: 12/703,387

(22) Filed: Feb. 10, 2010

(30) Foreign Application Priority Data
Dec. 10, 2009 (TW) 098142312

(51) Int. Cl. H04N 5/225; G03B 17/04; G02B 9/08

(52) U.S. Cl. 348/335; 396/349; 359/738; 348/E05.024

(57) ABSTRACT

A lens module of an imaging device includes a lens-barrel plate, a shutter plate and at least one elastic device. The lens-barrel plate includes at least one guide post, which is vertically arranged on the surface of the lens-barrel plate. The shutter plate includes at least one groove, which facilitates movement of the guide post in the groove. Each elastic device corresponds to an associated guide post and groove. Accordingly, the elastic device is compressed when external force is exerted on the lens-barrel plate and the shutter plate, and the elastic device recovers to separate the shutter plate from the lens-barrel plate when the external force is removed.

### CROSS-REFERENCE TO RELATED APPLICATIONS

The entire contents of Taiwan Patent Application No. 098142312, filed on Dec. 10, 2009, from which this application claims priority, are incorporated herein by reference.

### BACKGROUND OF THE INVENTION

1. Field of the Invention

The present invention generally relates to an imaging device, and more particularly to an imaging device having a lens module.

2. Description of Related Art

An imaging device, such as a digital camera or a digital camcorder, primarily combines a lens module with an image sensor to collect image light, which is then converted into electronic signals that may be stored, processed or transmitted afterwards.

Like most electronic devices, miniaturization is one of the product trends of the digital camera and the digital camcorder. Accordingly, miniaturizing the lens module continues as one of the design goals of the imaging device. For the purpose of achieving this goal, a thickness of the imaging device can be reduced by moving a shutter of the imaging device among different locations according to whether it is turned on or off. In other words, miniaturization of the lens module may be achieved by increasing the stroke of shutter movement.

In addition to reducing the thickness of the imaging device such as by increasing the stroke of shutter movement, a need has also existed for a novel lens module of simple construction, ease of assembly and attenuated contamination internally, for increasing manufacturing cost efficiency, product price competitiveness and production yield.

### SUMMARY OF THE INVENTION

In view of the foregoing, the embodiment of the present invention provides a lens module of an imaging device for increasing the stroke of shutter movement in order to miniaturize the lens module and reduce the thickness of the imaging device. Moreover, the embodiment of the present invention provides a lens module that has a simple construction and that may be assembled easily.

According to one embodiment of the present invention, the lens module of an imaging device primarily includes a lens-barrel plate, a shutter plate and at least one elastic device. The lens-barrel plate drives a lens to move along an optical axis. The lens-barrel plate includes a first center hole aligned with the optical axis and at least one guide post vertically arranged on a surface of the lens-barrel plate. The shutter plate includes a second hole aligned with the optical axis and at least one groove for facilitating movement of the guide post therein. Each elastic device corresponds to the guide post and the groove. Accordingly, the elastic device is compressed when an external force is exerted on the lens-barrel plate and the shutter plate while on the other hand the shutter plate is separated from the lens-barrel plate when the elastic device recovers following removal of the external force.

### BRIEF DESCRIPTION OF THE DRAWINGS

FIG. 1 shows a perspective exploded view of a lens module of an imaging device according to one embodiment of the present invention;

FIG. 2A shows a schematic cross section of the imaging device in a first state with the lens-barrel plate close to the shutter plate, which finally stops at a base;

FIG. 2B shows a schematic cross section of the imaging device in a second state illustrating that the lens-barrel plate, the shutter plate and the base are separated from each other;

FIG. 3A and FIG. 3B show partial schematic top views illustrating relative movement between the snap and the protrusion;

FIG. 4A and FIG. 4B show partial schematic top views illustrating relative movement between the hook and the protrusion; and

FIG. 5A and FIG. 5B show partial schematic top views illustrating relative movement between the hook and the shutter plate.

### DETAILED DESCRIPTION OF THE INVENTION

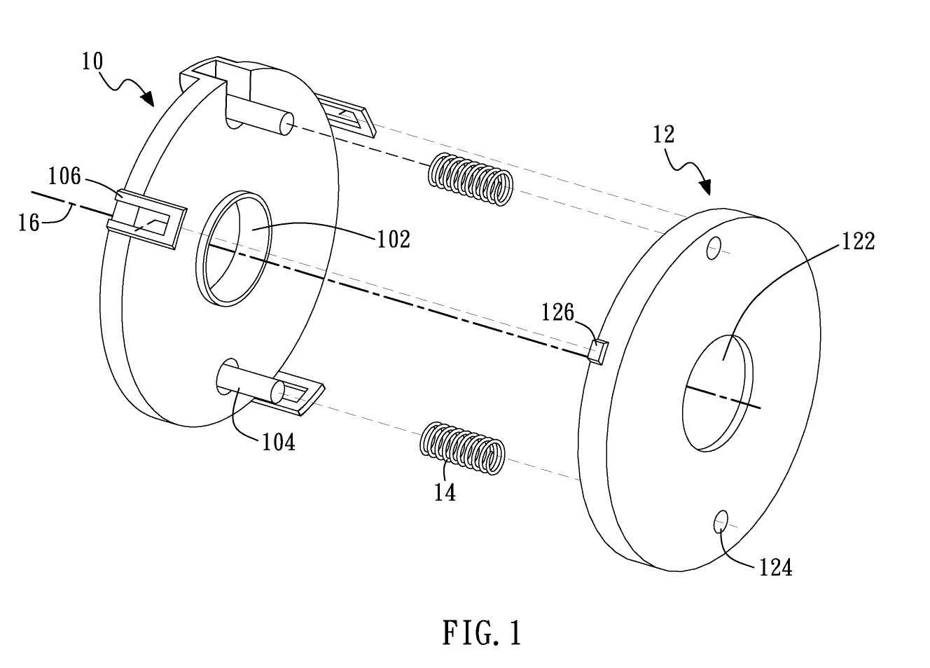

FIG. 1 shows a perspective exploded view of a lens module of an imaging device according to one embodiment of the present invention. In order to manifest aspects of the embodiment, only structures pertinent to the present embodiment are depicted for brevity. Although a digital camera is exemplified as the imaging device here, the present embodiment may well be adapted to other imaging devices such as a digital camcorder.

In the embodiment, the lens module mainly includes a lens-barrel plate 10, a shutter plate 12 and an elastic device (e.g., spring) 14. The digital camera generally includes multiple lens barrels, such as a front barrel, a center barrel and a rear barrel. The lens-barrel plate 10 shown in FIG. 1 belongs to the center barrel. The lens-barrel plate 10 drives a lens (not shown) to move along an optical axis 16. In the embodiment, the lens-barrel plate 10 primarily includes a first center hole 102, a guide post 104 and a snap 106. Specifically, the first center hole 102 is aligned with the optical axis 16. The guide post 104 is vertically arranged on the surface of the lens-barrel plate 10. At least one guide post 104 may be used, with two guide posts 104 being used in a preferred embodiment (e.g., as shown in FIG. 1). The snap 106 is arranged on and protrudes from the edge of the lens-barrel plate 10, for engagement with a protrusion (e.g., projection) of the shutter plate 12 to act as a limiting mechanism, as described in detail later in the specification. At least two snaps 16 may be used, with three snaps 16 being used in a preferred embodiment (e.g., as shown in FIG. 1).

The shutter plate 12 is one component of a shutter. In the embodiment, the shutter plate 12 mainly includes a second center hole 122, a groove 124 and a protrusion 126. Specifically, the second center hole 122 is aligned with the optical axis 16. The groove 124 may or may not pass through the shutter plate 12. The location of the groove 124 corresponds to the guide post 104 of the lens-barrel plate 10 for allowing the guide post 104 to move in the groove 124. Therefore, the number of the grooves 124 is typically equal to the number of the guide posts 104. The protrusion 126 arranged on and protruding from the edge of the shutter plate 12 corresponds to the snap 106 of the lens-barrel plate 10. Thus, the number of the protrusions 126 is usually equal to the number of the snaps 106.

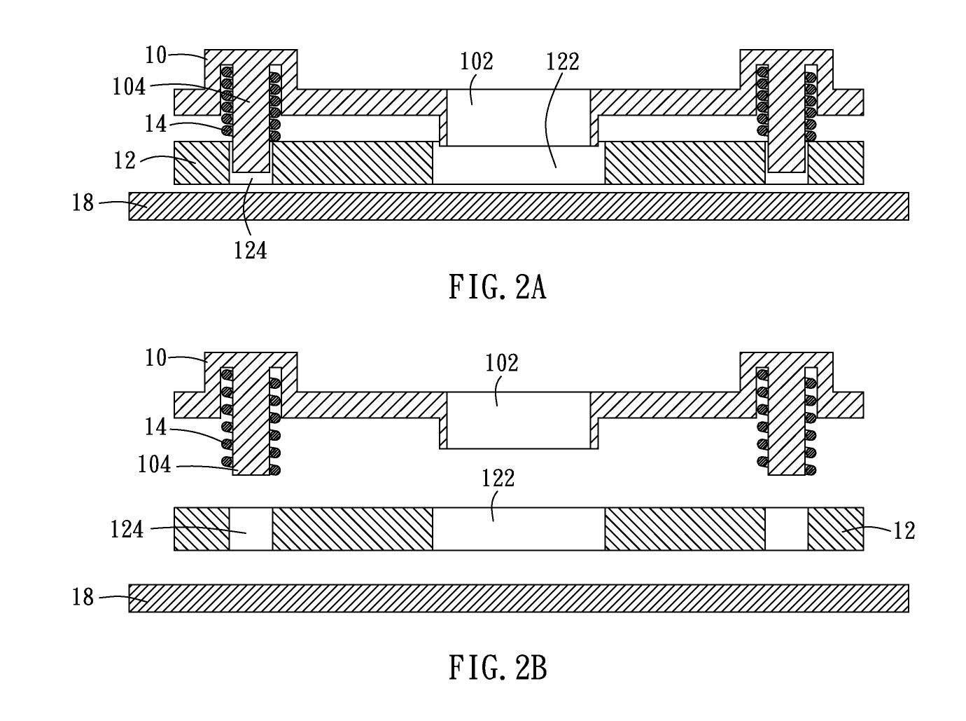

According to a feature of the lens module described above, when the imaging device enters a first state (e.g., a turned-off state or condition), an external force is exerted on one or more of the lens-barrel plate 10 and the shutter plate 12 such that the elastic device 14 is pressed (e.g., compressed) and the guide post 104 moves in the groove 124. As a result, the lens-barrel plate 10 becomes (e.g., moves, relatively speaking) close (e.g., closer) to the shutter plate 12. FIG. 2A is a schematic cross section of the imaging device in the first state, illustrating that the lens-barrel plate 10 presses the elastic device 14 and resulting in relative movement of the lens-barrel plate 10 toward the shutter plate (e.g., positioning the two such that the lens-barrel plate 10 is close or closer to the shutter plate 12), which finally stops at a fixed base 18 of the imaging device. Specifically, the elastic device 14 is passed by the guide post 104 and surrounds the guide post 104. One end of the elastic device 14 is pressed against a surface of the lens-barrel plate 10, and another end thereof is pressed against a surface of the shutter plate 12. The groove 124 has a diameter slightly larger than the diameter of the guide post 104, and the elastic device 14 has a diameter slightly larger than the diameter of the groove 124.

When the imaging device enters a second state (e.g., a turned-on state or condition), the external force is removed, allowing recovery of the elastic device 14 and separation (e.g., by the recovered elastic device 14) of the shutter plate 12 from the lens-barrel plate 10. FIG. 2B is a schematic cross section of the imaging device in the second state, illustrating that the elastic device separates the shutter plate 12 from the lens-barrel plate 10. Subsequently, the lens-barrel plate 10 and its associated lens are driven to move along the optical axis 16 for capturing an image. As a result, the lens-barrel plate 10, the shutter plate 12, and the base 18 are separated from each other.

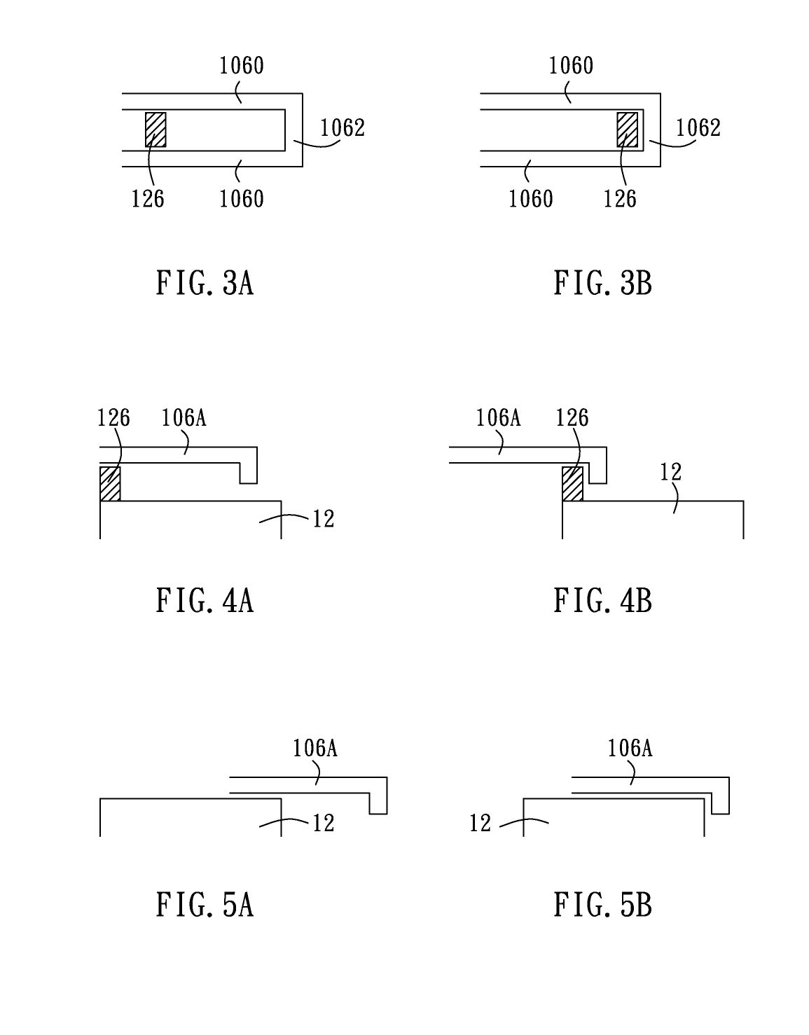

According to another aspect of the present invention, the snap 106 of the lens-barrel plate 10 and the protrusion 126 of the shutter plate 12 may operate as a limiting mechanism for limiting maximum stroke when the shutter plate 12 is separated from the lens-barrel plate 10. In the embodiment, each snap 106 is made of two strips 1060 and a stop 1062. Specifically, as exemplified in a partial schematic top view depicted in FIG. 3A, the two strips 1060 are separated from each other with a predetermined distance, and the resultant space between the two strips 1060 is used to accommodate the protrusion 126. The stop 1062 is arranged at the ends of the two strips 1060. FIG. 3B shows a partial schematic top view illustrating that the protrusion 126 stops at the stop 1062 when the shutter plate 12 and the lens-barrel 10 are separated with the maximum stroke.

The limiting mechanism of the embodiment may be modified to form equivalents or substantial equivalents. In another embodiment, as exemplified in a partial schematic top view depicted in FIG. 4A, a hook 106A arranged on and protruding from the lens-barrel plate 10 is to be correspondingly engaged with the protrusion 126. FIG. 4B shows a partial schematic top view illustrating that the hook 106A catches the protrusion 126 when the shutter plate 12 and the lens-barrel 10 are separated with the maximum stroke. In a further embodiment, as exemplified in a partial schematic top view depicted in FIG. 5A, the hook 106A is used while the protrusion 126 is omitted. FIG. 5B provides a partial schematic top view illustrating that the hook 106A catches the shutter plate 12 when the shutter plate 12 and the lens-barrel 10 are separated with the maximum stroke.

Although specific embodiments have been illustrated and described, it will be appreciated by those skilled in the art that various modifications may be made without departing from the scope of the present invention, which is intended to be limited solely by the appended claims.

What is claimed is:

1. A lens module of an imaging device, comprising:
a lens-barrel plate configured to drive a lens along an optical axis, the lens-barrel plate including a first center hole aligned with the optical axis and at least one guide post vertically arranged on a surface of the lens-barrel plate;
a shutter plate including a second hole aligned with the optical axis and at least one groove for facilitating movement of the guide post therein; and
at least one elastic device respectively corresponding to the guide post and the groove;
wherein exertion of an external force on the lens-barrel plate and the shutter plate accompanies compression of the elastic device and removal of the external force accompanies recovery of the elastic device and separation of the shutter plate from the lens-barrel plate by the recovered elastic device.

2. The lens module of claim 1, wherein the imaging device is one of the following: a digital camera and a digital camcorder.

3. The lens module of claim 1, further comprising at least two limiting mechanisms, arranged on at least one of the lens-barrel plate and the shutter plate, for limiting maximum stroke when the shutter plate is separated from the lens-barrel plate.

4. The lens module of claim 3, wherein each of said limiting mechanisms comprises:
a snap arranged on and protruding from an edge of the lens-barrel plate; and
a protrusion arranged on and protruding from an edge of the shutter plate, the protrusion corresponding to the snap.

5. The lens module of claim 4, wherein the snap comprises:
at least two strips, which are separated from each other to result in a space to accommodate the protrusion; and
a stop arranged on ends of the strips such that the protrusion stops at the stop when the shutter plate is separated from the lens-barrel plate with a maximum stroke.

6. The lens module of claim 3, wherein each said limiting mechanism comprises:
a hook arranged on and protruding from an edge of the lens-barrel plate for catching the shutter plate when the shutter plate is separated from the lens-barrel plate with a maximum stroke.

7. The lens module of claim 3, wherein each of said limiting mechanisms comprises:
a hook arranged on and protruding from an edge of the lens-barrel plate; and
a protrusion arranged on and protruding from an edge of the shutter plate, the protrusion corresponding to the hook;
whereby the hook catches the protrusion when the shutter plate is separated from the lens-barrel plate with a maximum stroke.

8. The lens module of claim 1, wherein the elastic device is a spring, which is passed by and surrounds the guide post.

9. The lens module of claim 8, wherein the groove has a diameter larger than a diameter of the guide post, and the spring has a diameter larger than a diameter of the groove.

10. The lens module of claim 1, wherein the groove passes through the shutter plate.

11. The lens module of claim 10, further comprising a base fixed on the imaging device such that the shutter plate stops at the base when the lens-barrel plate and the shutter plate are close to each other according to the external force.

12. A method of using a lens module of an imaging device, comprising:
providing a lens-barrel plate with a first center hole and at least one guide post vertically arranged on a surface of the lens-barrel plate;
providing a shutter plate with a second center hole and at least one groove;
providing at least one elastic device respectively corresponding to the guide post and the groove;
aligning the first center hole and the second center hole with an optical axis and aligning the guide post with the corresponding groove;
exerting a force on the lens-barrel plate and the shutter plate when the imaging device enters a first state such that the guide post moves in the groove and the elastic device is compressed, whereby a separation of the lens-barrel plate and the shutter plate diminishes with the shutter plate stopping at a base of the imaging device;
removing the force when the imaging device enters a second state such that the elastic device separates the lens-barrel plate from the shutter plate, whereby the lens-barrel plate, the shutter plate and the base separate from each other; and
driving a lens along the optical axis by the lens-barrel plate for capturing an image.

13. The method of claim 12, wherein the imaging device is one of the following: a digital camera and a digital camcorder.

14. The method of claim 12, wherein the first state is a turned-off condition and the second state is a turned-on condition.

15. The method of claim 12, further comprising:
providing at least two limiting mechanisms, arranged on at least one of the lens-barrel plate and the shutter plate; and
stopping relative movement between the lens-barrel plate and the shutter plate when the lens-barrel plate is separated from the shutter plate with a maximum stroke.

16. The method of claim 12, wherein the step of providing the elastic device comprises:
using a spring that is passed by the guide post and surrounds the guide post, with one end of the elastic device being pressed against a surface of the lens-barrel plate and another end thereof being pressed against a surface of the shutter plate.

17. The method of claim 16, wherein the groove has a diameter larger than a diameter of the guide post, and the spring has a diameter larger than a diameter of the groove.
